(19) United States
(12) Patent Application Publication
(10) Pub. No.: US 2007/0250654 A1
(43) Pub. Date: Oct. 25, 2007

(54) System and method for completing a plurality of grant applications

(76) Inventor: Jason Saul, Chicago, IL (US)

Correspondence Address: FACTOR & LAKE, LTD, 1327 W. WASHINGTON BLVD., SUITE 5G/H, CHICAGO, IL, 60607, US

(21) Appl. No.: 11/725,961

(22) Filed: Mar. 20, 2007

Related U.S. Application Data
(60) Provisional application No. 60/784,043, filed on Mar. 20, 2006.

(51) Int. Cl. G06F 13/36

(52) U.S. Cl. 710/310

(57) ABSTRACT

A system and method for completing a plurality of grant applications is disclosed.

### RELATED APPLICATIONS AND DOCUMENTS

This application claims the benefit of U.S. Provisional Patent Application Ser. No. 60/784,043, filed on Mar. 21, 2006, and incorporated herein by reference.

### FIELD OF THE INVENTION

The present invention relates generally to information distribution and, more particularly, to a system and method for completing a plurality of grant applications with data from a centralized database.

### FEDERALLY SPONSORED RESEARCH OR DEVELOPMENT

None.

### BACKGROUND OF THE INVENTION

In 2003, the top 20,000 foundations issued 1,200,000 grants to nonprofits. There is no precise data on the total number of grant applications submitted each year to foundations. Based on estimated turn-down rates of 75-80%, however, there were between 5,000,000 and 8,000,000 applications for funding that year. With approximately 850,000 public charities in the U.S., that is an average of 6-9 grant applications per organization.

The cost to nonprofits of pursuing grant funding is significant. Fundraising cost estimates run as high as $0.20/dollar raised. To put that in perspective, the cost of raising funds for businesses ranges from 2-5%. Based on total foundation grants of $30Bn in 2003, the cost to nonprofits of raising this money could be as high as $6Bn. That's $6Bn spent on overhead at the expense of charitable beneficiaries. In fact, it is very likely that pursuing grant donors could be even more expensive, given the high administrate burden associated with each grant—estimated at 62 hrs per grant. In addition, since every foundation has slightly different grant application forms, a significant amount of that effort is being replicated.

For foundations, grant making is also costly. Processing a geometrically-growing number of grant application each year represents a significant administrative cost for America's foundations. Even though some 2,500 foundations now use online technologies to receive applications, most grant proposals are still reviewed manually by either program staff or consultants. The final reporting process is equally burdensome. Many final reports are either missing or never received—one out of three, on average. Those that are received are often not read or stored in file drawers, as few foundations have the capacity to analyze lessons learned or benchmarks from their grants in any systematic or referenceable way.

The philanthropic sector is not the first sector to face these challenges. In the mid-1970s, a group of colleges got together and agreed on a common application. Today, 276 of the leading universities accept a common application. Just about every U.S. medical school now accepts a common application. And medical residency programs at almost every major teaching hospital in the country accept a common application. Even the federal government has standardized grant making at 26 federal agencies through a common application called “Grants.gov.”

Foundations have made some progress, too. Over the last few decades, 14regional associations of grantmakers (RAs) have created common regional grant applications for their members. Eight of these RAs have also created a common final report. Among these are: Associated Grant Makers, Inc. (MA); Connecticut Council for Philanthropy (CT); Council of Michigan Foundations; Delaware Valley Grantmakers (PA); Donors Forum of Chicago; New York/New Jersey Area Common Application Form; Rochester Grantmakers Forum; and, Washington Regional Association of Grantmakers.

Combined, there are a total of 623 funders accepting a common application of one form or another. Approximately 300-400 of these funders also accept a common final report. There are also various other miscellaneous government, civic and philanthropic organizations that have promulgated a common grant application, each with only a handful of funders. While together these represent only a small slice of the total number of foundations, most of the leading corporate, private and family foundations are among them.

In view of the above, it is therefore desirable to provide a system and method that provides funders with the information they desire while reducing the burden on the requestors in having to complete multiple different forms.

### SUMMARY OF INVENTION

The present invention relates to a system and method for completing a plurality of grant applications from a centralized database.

According to one aspect of the invention, a web-based system and method is provided for completing a plurality of grant applications by entering data within a standardized application.

According to another aspect of the invention, a system and method is provided that allows a user to complete a select group of grant applications by entering data within a standardized application.

In accordance with another aspect of the invention, a method is provided for processing over a computer network a standardized grant request form directed by multiple nonprofit organizations to multiple donors. The form is processed by a third party servicer that is neither one of the donors nor one of the nonprofit organizations. The method includes the step of presenting over a computer network to the nonprofit organizations the standardized grant request form that is generic to the multiple donors wherein the form includes fields for the nonprofit organization to enter information. The method also includes entering nonprofit organization information onto the standardized form. The third party servicer also receives, over the computer network, the nonprofit organization information and electronic payment information entered by the nonprofit organization. The third party servicer processes an electronic payment associated with the standardized grant request form wherein the processed payment is from the nonprofit organization to the servicer. Also, the third party servicer processes the nonprofit organization information in accordance with the preferences of the donor to which the standardized grant request form is directed to make the nonprofit organization information available to the donor.

In accordance with yet another aspect of the invention, a method is provided for processing over a computer network a form directed by multiple nonprofit organizations to multiple donors, the form being processed by a third party servicer that is neither one of the donors nor one of the nonprofit organizations. The method includes the step of a third party servicer presenting over a computer network a standardized grant request form that is generic to the multiple donors wherein the form includes fields to enter nonprofit organization information. The third party servicer receives, over the computer network, the nonprofit organization information and electronic payment information entered by the nonprofit organization. The third party servicer processes an electronic payment associated with the standardized grant request form wherein the processed payment is from the nonprofit organization to the servicer. The third party servicer provides the nonprofit organization information to the donor to which the standardized grant request form is directed.

In accordance with yet another aspect of the invention, an apparatus is provided for processing, over a computer network, a form directed by multiple nonprofit organizations to multiple donors. The form is processed by a third party servicer that is neither one of the donors nor one of the nonprofit organizations. The system includes a processor for executing computer instructions, the processor associated with the third party servicer. A computer accessible memory is provided in data communication with the processor and storing computer instructions for presenting over a computer network by the third party servicer to the nonprofit organization a standardized grant request form that is generic to the donors, the standardized grant request form including fields to enter nonprofit organization information. The third party servicer receives over the computer network the nonprofit organization information and electronic payment information entered by the nonprofit organization. The third party servicer processes an electronic payment associated with the standardized grant request form, the processed payment being from the nonprofit organization to the servicer. Further, the third party servicer provides the nonprofit organization information to the donor to which the standardized grant request form is directed.

In accordance with still yet another aspect of the invention, a method is provided of processing over a computer network forms directed by multiple nonprofit organizations to donors. The forms are administered by a third party servicer that is neither one of the donors nor one of the nonprofit organizations. The method includes the step of receiving by a donor from a third party servicer nonprofit organization information in a format specified by the donor. The nonprofit organization information is derived from a standardized grant request form that is generic to at least two donors and identified primarily with the third party servicer rather than with the donor. The standardized form is presented to a user over a computer network by the third party servicer. The standardized form includes fields for data to be inserted manually by the user or automatically wherein the information in the completed form is posted to the third party servicer. The form is received from the user with an electronic payment associated therewith. Thus, the user is provided with a standardized form and the donor is relieved from the administrative burden of processing forms.

Other embodiments, systems, methods, features, and advantages of the present invention will be, or will become, apparent to one having ordinary skill in the art upon examination of the following drawings and detailed description. It is intended that all such additional systems, methods, features, and advantages included within this description be within the scope of the present invention, and be protected by the accompanying claims.

### DESCRIPTION OF THE DRAWINGS

The invention may be better understood with reference to the following drawings. The components in the drawings are not necessarily to scale, emphasis instead being placed upon illustrating the principles of the invention. In the drawings, like reference numerals designate corresponding parts throughout the several views.

FIG. 1 is a simplified block diagram illustrating an embodiment of a system in accordance with the present invention;

FIG. 2 is a simplified flow diagram of an embodiment in accordance with the present invention;

FIG. 3 is a simplified diagram of a process in accordance with the present invention; and,

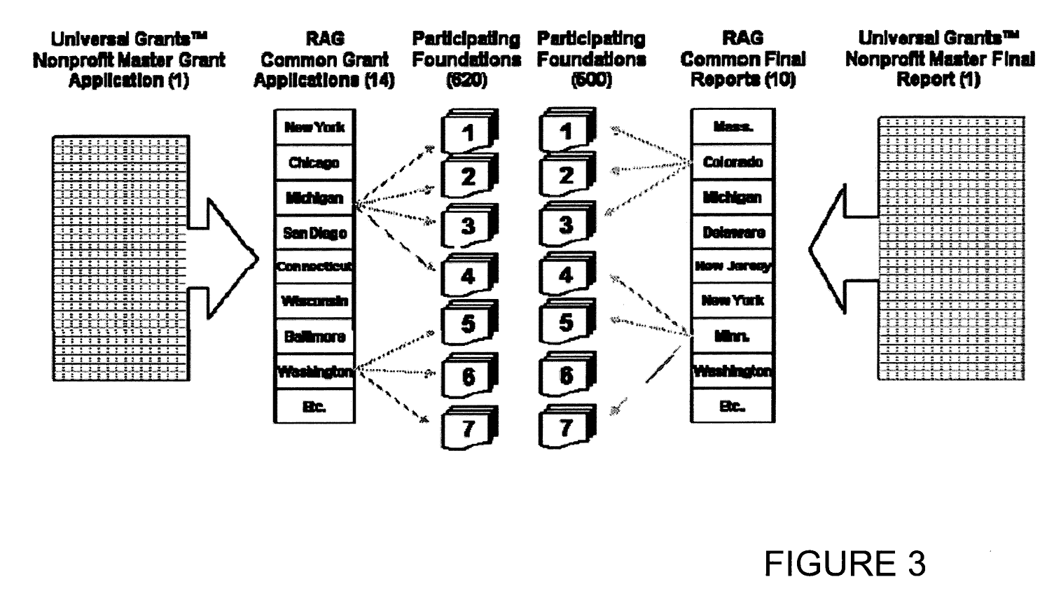

FIG. 4 is a simplified diagram of a system workflow in accordance with the present invention.

### DESCRIPTION OF DETAILED EMBODIMENTS

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

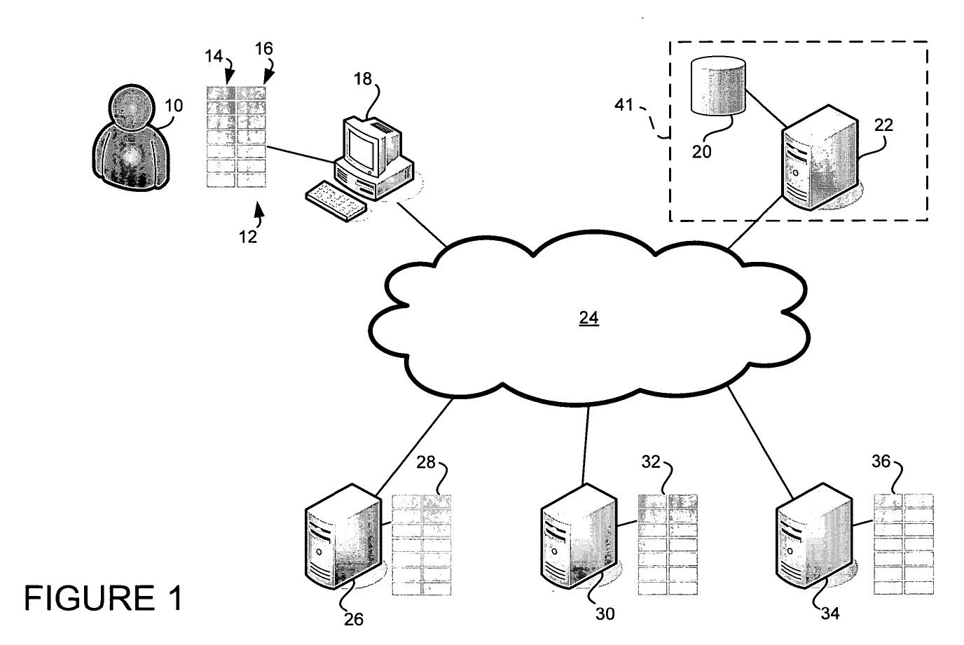

Turning to FIG. 1, a simplified block diagram is provided of a system in accordance with the present invention. As shown in FIG. 1, the system can include a data entry terminal 18 such as a personal computer or other conventional data input device wherein a user 10 enters data. Preferably, but not necessarily, the data entry terminal 18 has a graphical browser such as Microsoft Internet Explorer or other software application loaded thereon for displaying Web pages.

The user 10 can be a nonprofit (a.k.a., not-for-profit) organization, group or person desiring funding. As such, the primary objective of the nonprofit organization is to support an issue or matter of private interest or public concern for non-commercial purposes. Such nonprofits can be involved in a wide range of areas relating to, for example, the arts, charities, early childhood education, politics, religion and research.

As indicated previously, the user 10 enters data in response to a form 12 displayed on the data entry device 18. The form 12 can be provided by the data entry terminal 18 or a remote sever 22 via network 24. Accordingly, the network 24 can be a local area network, a wide area network, or other network including, but not limited to, the internet.

The form 12 can be a Webpage the like and include, but is not necessarily limited to, common fields 14 comprising questions or other requests for information. In response thereto, the user 10 enters responses 16 corresponding to the fields 14. The form 12 can be generated and provided by a third party servicer as described in detail further herein. The form 12 can include several categories such as, but not limited to, nonprofit organization information, grant request information, organization narrative information, financial information and attachments.

The nonprofit organization information can include, but is not limited to, legal name of organization, doing business as name, employer identification number, address, phone number, fax number, e-mail address, 501c3 status, executive director name, board president or chair name, frequency of board meetings, number of full-time staff, number of part-time staff, staff and/or board diversity, number of volunteers, United Way affiliation, listing of government grants, list of population served, list of outcomes, geography served and entity type.

The grant request information can include, but is not limited to, a description of the program or project for which the grant is requested, amount requested, type of request, program status, any previous grants received, period covered, strategic link to funder, community needs addressed, target population served, number served, outcomes, indicators, activities, logic model, timeline, sustainability, partners, evaluation, funding sources and key staff.

The organizational narrative information can include, but is not limited to, mission, background and/or history, organization strategy, constituents served, community needs addressed, organizational capacity and capital campaign.

The financial information can include, but is not limited to, annual budget, fiscal year end, program and/or project budget, revenue sources, financial notes and accountability.

The attachments can include, but is not limited to, an IRS 501c3 determination letter, audited financials, general operating budget, project budget, current board list, current financials, annual report, state registration, letters of partnership agreement, organizational chart, grantee report, letters of support, IRS Form 990, recent press articles, logic model and brochures.

In an embodiment, but not necessarily, the responses 16 from the user are stored in a master database 20 that can be associated with server 22. Alternatively, the responses can be stored within the data entry terminal 18.

Preferably, but not necessarily, the master database 20 and the server 22 is associated with a third party servicer 41 wherein the servicer is not affiliated with the nonprofit user or the foundation(s) in which the request is made. Moreover, the server 22 is configured to process electronic payments using information received from the donors or nonprofits.

At least a portion of the stored responses can be used to populate forms specific to one or more foundations. For instance, the user 10 can direct the server 22, via terminal 18 and network 24, to populate the fields of the forms 28, 32 and 36 specific to foundations 26, 30 and 34, respectively, with the data stored in the master data set 20. Alternatively, the user can direct the server to populate the fields of only a selected number or group of foundations, or only one or more specific foundations.

In an embodiment, the system can include a combination of common fields from, for example, 14 different Common Grant Applications from regional groups of foundations. Together, this master set of data can satisfy the grant application requirement of, for example, more than 600 foundations that have signed on to one of the 14 different common grant applications. In an embodiment, the system provides a master list of fields, and the process of creating a centralized database that, when a foundation is selected by a nonprofit company to apply, populates from the master set of data a generic grant application form with the specific subset of data fields required by each funder (e.g., if there are 1-150 data fields, and a foundation belongs to Common Grant Application Form for California, requiring fields 1-34, 39 and 88, the system would automatically generate a form from the database on the fly with only those fields). In an embodiment, the system would not require the user to identify which fields each foundation needs. Instead, the user just selects the foundation and then the system allows the user to generate and submit a grant application to multiple foundations by email (e.g., by submitting pdf formatted files) at once. The owner of the system (e.g., owner of server 22 in FIG. 1) can charge for the service on a per application basis, a membership fee, or by other means.

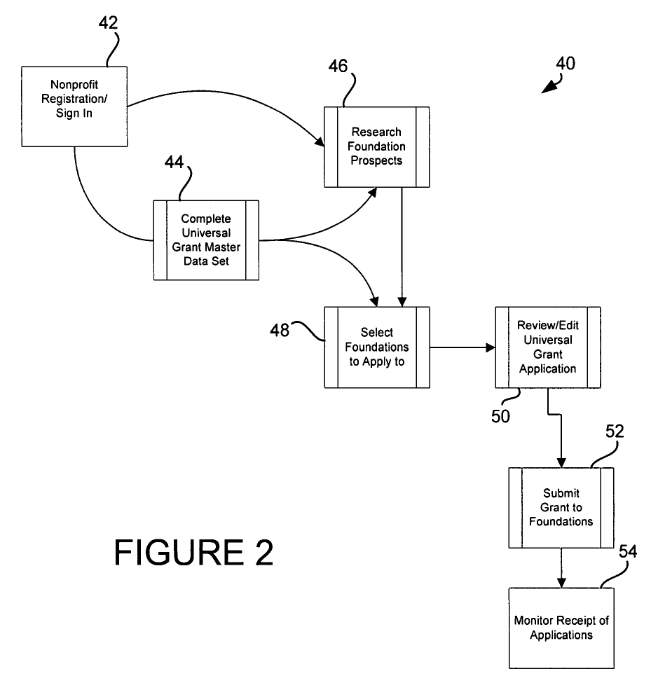

Turning to FIG. 2, a simplified flow diagram of a method in accordance with the present invention is depicted. In the flow diagram 40, at step 42, a nonprofit organization registers or signs into the system. Then, the nonprofit organization can complete a universal grant master data set at step 44 or research foundation prospects at step 46, or both. Next, at step 48, the nonprofit organization can selection foundations to apply to. Then, the nonprofit organization can review and/or edit the universal grant application at step 50, submit grants to foundations at step 52, and monitor receipt of applications at step 54.

As stated above, in an embodiment, a third party servicer provides an online grant service that allows nonprofits to submit a single grant application to multiple foundations. The service can also allow nonprofits to submit a single final report to multiple foundations.

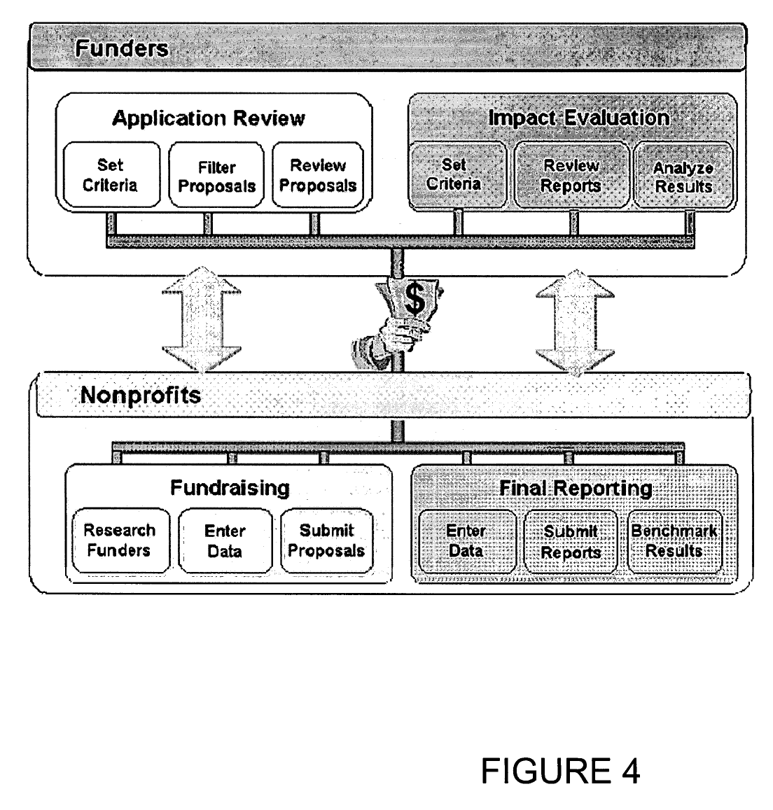

For instance, as depicted in FIG. 4, the servicer can initially utilize the regional common grant application forms current in place at fourteen (14) regional associations of grantmakers (RAs).

From a functional point of view, nonprofits and foundations can each have different roles in the system. For nonprofits, the system can serve principally as an application and reporting engine. Nonprofits can research all of the foundations in the system to assess their strategic fit, enter and store application data, and submit applications to funders. Once a grant has been completed, or on an interim basis, a nonprofit using the reporting service can enter grant results and narrative information, and submit their report to multiple funders. Moreover, nonprofits can search past grants in the system and benchmark against other organizations'results.

For funders, the system facilitates application filtering and review and serves as an electronic repository for final reports about grant results. Program officers and grants administrators can proactively set certain screening criteria for applicants, thereby filtering out unqualified organizations and saving both sides unnecessary time and effort. The filtering can be based, for example, on five (5) indexes that enable the foundation to receive applications through the system that match its goals. In an embodiment, the indexes are: 1) the National Taxonomy of Exempt Entities; 2) the National Program Classification Code; 3) the common outcomes the nonprofit is trying to create; 4) the NPC beneficiary code as a result of the nonprofit's services; and 5) the geography regarding where the nonprofit is delivering its services.

The common outcomes the nonprofit is trying to create can include, but is not necessarily limited to: advance the field, align resources with results, build brand recognition, build external visibility/credibility, change behavior, change condition/status, change organizational culture/incentives, convene key stakeholders, deliver services effectively, develop new approaches/techniques, improve access to services, improve attendance, improve attitude, improve customer satisfaction, improve employment, improve funding and financial sustainability, improve health, improve participation, improve partnerships/alliances, improve program completion, improve program/organizational sustainability, improve student achievement, improve teacher practice, increase advocacy/support of issue, increase awareness/visibility of an issue, increase community engagement, increase employee engagement, increase enrollment/ participation, increase family support, increase knowledge, increase scale/reach, increase skills, influence public policy, recruit/retain employees, strengthen organizational development/capacity, and use resources efficiently.

Funders can also review proposals online or receive the applications in a standard xml format and import the data into an existing grants management database. Also, for final reporting funders can receive, store and review all final reports online, and analyze results of individual and cluster grants. FIG. 5 illustrates the system workflow in an embodiment in accordance with the present invention.

In an embodiment, for nonprofit users, the third party servicer charges a nominal per/application or per/report fee only when either is actually submitted to a funder. The fee can be based on the number of funders to whom application or reports are submitted. The third party can also provide a “bulk rate” package for more frequent users.

In an embodiment, for foundation users, the third party servicer does not charge the foundations. However, the third party may charge a flat annual membership fee to use the service to set filters, review applications and review final reports. The membership fee can also cover the costs associated with maintaining the common application and report (i.e., updates and revisions) and ongoing research and development on uses of data in the system.

In satisfy the various application and reporting requirements of thousands of different funders, two approaches can be applied: 1) a common application and final report; and, 2) a quasi-common application and final report.

In the common application and final report approach, a field-wide agreement is forged among leading funders on a common set of requirements. Those requirements, once accepted by a critical mass of funders, is then used to populate a database for use by nonprofits and foundations for submitting applications and final reports to multiple funders.

In the quasi-common application and final report approach, a master set of data field is developed that is sufficient to fulfill the existing requirements of each of the fourteen (14) regional common application and reports. Any time a nonprofit submits an application or report to a foundation that is a member of one of these 14 regional associations, only the data required for that region is pulled from the master set and submitted.

On the final reporting, a similar approach is applied. In an embodiment, a common set of taxonomies is used (e.g., standard or common outcomes as previously described above, standard program types, standard beneficiary types, and the like) and evaluative question for standardizing final reporting across foundations.

As also indicated previously, in an embodiment, the third party servicer allows individual donors and foundations to find the grant opportunities they are look for—and the suitable nonprofits to deliver the results they care about. The third party servicer can use five (5) key indexes to classify every nonprofit that enters an application into the system. Donors can come to the online marketplace (i.e., server 22 of FIG. 1) free of charge and research grant opportunities and find nonprofits that are aligned with their interests.

In an embodiment, the matching is performed via server 22 of FIG. 1 by lining up the nonprofit profile and the donor profile and assessing “fit” by seeing how many fields match and connect the donor/nonprofit. The system also uses this profile to “suggest” nonprofit opportunities to donors by tracking the behavior of donors with similar profiles. The five (5) criteria can include: 1) the National Taxonomy of Exempt Entities, which is a public taxonomy, similar to an SIC code, that classifies the type of entity (e.g., school, museum, and the like); 2) the National Program Classification Code, which is a public taxonomy that classifies nonprofits by type of work they do (e.g., literacy training, counseling, and the like); 3) outcomes that are classified by the type of results a nonprofit is trying to create (e.g., increase employment, reduce violence, and the like as previously described above); 4) NPC Beneficiary Code comprising a conventional public classification that specifies the people benefiting from the nonprofit's services (e.g., women, youth age 5-12, elderly, disabled, and the like); 5) geography comprising a conventional public list of geographies, such as by city or zip code, to specify where the nonprofits is delivering its services.

In an embodiment, donors and foundations have free access to the marketplace (i.e., server 22 of FIG. 1). However nonprofits are charged an additional service fee to have their profile “posted” or made live in the marketplace for donors to view.

It should be emphasized that the above-described embodiments of the present invention, particularly, any “preferred” embodiments, are possible examples of implementations merely set forth for a clear understanding of the principles of the invention. Many variations and modifications may be made to the above-described embodiment(s) of the invention without substantially departing from the spirit and principles of the invention. All such modifications are intended to be included herein within the scope of this disclosure and the present invention, and protected by the following claims.

What is claimed is:

1. A method of processing over a computer network a standardized grant request form directed by multiple nonprofit organizations to multiple donors, the form being processed by a third party servicer that is neither one of the donors nor one of the nonprofit organizations, the method comprising:
presenting over a computer network to the nonprofit organizations the standardized grant request form that is generic to the multiple donors, and the standardized form including fields for the nonprofit organization to enter information;
entering nonprofit organization information onto the standardized form;
receiving by the third party servicer over the computer network the nonprofit organization information and electronic payment information entered by the nonprofit organization;
processing by the third party servicer an electronic payment associated with the standardized grant request form, the processed payment being from the nonprofit organization to the servicer;
processing by the third party servicer the nonprofit organization information in accordance with the preferences of the donor to which the standardized grant request form is directed to make the nonprofit organization information available to the donor.

2. The method of claim 1 wherein the donor is a foundation, grantmaker or individual.

3. The method of claim 1 wherein the form includes an indication of the donors it is directed to.

4. The method of claim 1 further comprising the step of storing the entered nonprofit organization information in a database.

5. The method of claim 1 further comprising the steps of storing the entered nonprofit organization information in a database and populating grant application forms specific to one or more of the donors in response to a command from the nonprofit organization.

6. The method of claim 1 further comprising the steps of storing the entered nonprofit organization information in a database and requiring a membership fee to access the database.

7. The method of claim 1 further comprising the steps of storing the entered nonprofit organization information in a database, populating grant application forms specific to one or more of the donors in response to a command from the nonprofit organization, and requiring a fee to populate each of the grant applications.

8. The method of claim 1 wherein the form satisfies a requirement of at least one regional association of grantmakers.

9. The method of claim 1 wherein the form satisfies a requirement of at least two regional associations of grantmakers.

10. The method of claim 1 wherein the servicer provides to the nonprofit organizations, over the network, a common final report for completion by the nonprofit organizations and wherein the report satisfies the requirements of the foundations.

11. The method of claim 1 wherein the servicer recommends at least one of the nonprofit organizations to at least one of the foundations based on selection criteria.

12. The method of claim 1 wherein the servicer recommends at least one of the foundations to at least one of the nonprofit organizations based on selection criteria.

13. The method of claim 1 in which entering payment information includes entering payment information onto the standardized form.

14. The method of claim 1 further comprising storing by the third party the nonprofit organization information entered onto the standardized form.

15. The method of claim 1 in which the receiving by the third party servicer over the computer network the nonprofit organization information and electronic payment information includes verifying that the nonprofit organization information satisfies criteria specified by the one of the multiple foundations to which the form is directed.

16. A method of processing over a computer network a form directed by multiple nonprofit organizations to multiple donors, the form being processed by a third party servicer that is neither one of the donors nor one of the nonprofit organizations, the method comprising:
presenting over a computer network by a third party servicer a standardized grant request form that is generic to the multiple donors, the standardized form including fields to enter nonprofit organization information;
receiving by the third party servicer over the computer network the nonprofit organization information and electronic payment information entered by the nonprofit organization;
processing by the third party servicer an electronic payment associated with the standardized grant request form, the processed payment being from the nonprofit organization to the servicer; and
providing by the third party servicer the nonprofit organization information to the donor to which the standardized grant request form is directed.

17. The method of claim 16 wherein the donor is a foundation, grantmaker or individual.

18. The method of claim 16 wherein the form includes an indication of the donors it is directed to.

19. The method of claim 16 further comprising the step of storing the entered nonprofit organization information in a database.

20. The method of claim 16 further comprising the steps of storing the entered nonprofit organization information in a database and populating grant application forms specific to one or more of the donors in response to a command from the nonprofit organization.

21. The method of claim 16 further comprising the steps of storing the entered nonprofit organization information in a database and requiring a membership fee to access the database.

22. The method of claim 16 further comprising the steps of storing the entered nonprofit organization information in a database, populating grant application forms specific to one or more of the donors in response to a command from the nonprofit organization, and requiring a fee to populate each of the grant applications.

23. The method of claim 16 wherein the form satisfies a requirement of at least one regional association of grantmakers.

24. The method of claim 16 wherein the form satisfies a requirement of at least two regional associations of grantmakers.

25. The method of claim 16 wherein the servicer provides to the nonprofit organizations, over the network, a common final report for completion by the nonprofit organizations and wherein the report satisfies the requirements of the foundations.

26. The method of claim 16 wherein the servicer recommends at least one of the nonprofit organizations to at least one of the foundations based on selection criteria.

27. The method of claim 16 wherein the servicer recommends at least one of the foundations to at least one of the nonprofit organizations based on selection criteria.

28. The method of claim 16 in which entering payment information includes entering payment information onto the standardized form.

29. The method of claim 16 further comprising storing by the third party the nonprofit organization information entered onto the standardized form.

30. The method of claim 16 in which receiving by the third party servicer over the computer network the nonprofit organization information and electronic payment information includes verifying that the nonprofit organization information satisfies criteria specified the multiple foundations to which the form is directed.

31. An apparatus for processing over a computer network a form directed by multiple nonprofit organizations to multiple donors, the form being processed by a third party servicer that is neither one of the donors nor one of the nonprofit organizations, the system comprising:
a processor for executing computer instructions, the processor associated with the third party servicer; and
computer accessible memory in data communication with the processor and storing computer instructions for:
presenting over a computer network by the third party servicer to the nonprofit organization a standardized grant request form that is generic to the donors, the standardized grant request form including fields to enter nonprofit organization information;
receiving by the third party servicer over the computer network the nonprofit organization information and electronic payment information entered by the nonprofit organization;
processing by the third party servicer an electronic payment associated with the standardized grant request form, the processed payment being from the nonprofit organization to the servicer; and,
providing by the third party servicer the nonprofit organization information to the donor to which the standardized grant request form is directed.

32. The apparatus of claim 31 wherein the donor is a foundation, grantmaker or individual.

33. The apparatus of claim 31 wherein the form includes an indication of the donors it is directed to.

34. The apparatus of claim 31 further comprising the step of storing the entered nonprofit organization information in a database.

35. The apparatus of claim 31 further comprising the steps of storing the entered nonprofit organization information in a database and populating grant application forms specific to one or more of the donors in response to a command from the nonprofit organization.

36. The apparatus of claim 31 further comprising the steps of storing the entered nonprofit organization information in a database and requiring a membership fee to access the database.

37. The apparatus of claim 31 further comprising the steps of storing the entered nonprofit organization information in a database, populating grant application forms specific to one or more of the donors in response to a command from the nonprofit organization, and requiring a fee to populate each of the grant applications

38. The apparatus of claim 31 wherein the form satisfies a requirement of at least one regional association of grantmakers.

39. The apparatus of claim 31 wherein the form satisfies a requirement of at least two regional associations of grantmakers.

40. The apparatus of claim 31 further comprising a common final report provided by the servicer to the nonprofit organizations over the network, the common final report completed by the nonprofit organizations and satisfying the requirements of the foundations.

41. The apparatus of claim 31 further comprising a recommendation of at least one of the foundations wherein the recommendation is provided by the servicer to at least one of the nonprofit organizations and is based on selection criteria.

42. The apparatus of claim 31 further comprising a recommendation of at least one of the nonprofit organizations wherein the recommendation is provided by the servicer to at least one of the foundations and is based on selection criteria.

43. The apparatus of claim 31 in which the computer accessible memory storing computer instructions stores instructions for verifying, in accordance with verification criteria, nonprofit organization information entered on the form.

44. The apparatus of claim 31 further comprising computer accessible memory storing a nonprofit organization data database that stores information entered onto the form by the nonprofit organization.

45. A method of processing over a computer network forms directed by multiple nonprofit organizations to donors, the forms process being administered by a third party servicer that is neither one of the donors nor one of the nonprofit organizations, the method comprising:
receiving by a donor from a third party servicer nonprofit organization information in a format specified by the donor, the nonprofit organization information being derived from a standardized grant request form that is generic to at least two donors and identified primarily with the third party servicer rather than with the donor, the standardized form being presented to a user over a computer network by the third party servicer, the standardized form including fields for data to be inserted manually by the user or automatically, the information in the completed form being posted to the third party servicer; and
receiving from the user via the third party servicer an electronic payment associated with the standardized form;
thereby providing to the user a standardized form, while relieving the foundation of the administrative burden of processing forms.

46. The method of claim 45 wherein the donor is a foundation, grantmaker or individual.

47. The method of claim 45 wherein the form includes an indication of the donors it is directed to.

48. The method of claim 45 further comprising the step of storing the entered nonprofit organization information in a database.

49. The method of claim 45 further comprising the steps of storing the entered nonprofit organization information in a database and populating grant application forms specific to one or more of the donors in response to a command from the nonprofit organization.

50. The method of claim 45 further comprising the steps of storing the entered nonprofit organization information in a database and requiring a membership fee to access the database.

51. The method of claim 45 further comprising the steps of storing the entered nonprofit organization information in a database, populating grant application forms specific to one or more of the donors in response to a command from the nonprofit organization, and requiring a fee to populate each of the grant applications

52. The method of claim 45 wherein the form satisfies a requirement of at least one regional association of grantmakers.

53. The method of claim 45 wherein the form satisfies a requirement of at least two regional associations of grantmakers.

54. The method of claim 45 wherein the servicer provides to the nonprofit organizations over the network a common final report for completion by the nonprofit organizations and wherein the report satisfies the requirements of the foundations.

55. The method of claim 45 wherein the servicer recommends at least one of the nonprofit organizations to at least one of the foundations based on selection criteria.

56. The method of claim 45 wherein the servicer recommends at least one of the foundations to at least one of the nonprofit organizations based on selection criteria.
